(19) United States
(12) Patent Application Publication
(10) Pub. No.: US 2015/0258996 A1
(43) Pub. Date: Sep. 17, 2015

(54) METHOD FOR PROVIDING A CONTEXT BASED COACHING MESSAGE TO A DRIVER OF A VEHICLE

(71) Applicant: VOLVO LASTVAGNAR AKTIEBOLAG, Göteborg (SE)

(72) Inventors: Trent Victor, Vastra Frolunda (NO); Peter Kronberg, Karna (SE)

(73) Assignee: VOLVO LASTVAGNAR AB, Göteborg (SE)

(21) Appl. No.: 14/428,071

(22) PCT Filed: Jan. 15, 2013
(86) PCT No.: PCT/SE2013/000005

§ 371 Date: Mar. 13, 2015

(30) Foreign Application Priority Data
Sep. 17, 2012 (SE) 1251039-2

(51) Int. Cl. B60W 40/09

(52) U.S. Cl. CPC B60W 40/09

(57) ABSTRACT

A method is provided for providing a coaching message to a driver of a vehicle for encouraging a desired driving behavior of the vehicle, the coaching message provided by a coaching arrangement included with the vehicle, the method including determining a driving context for the vehicle, determining a coaching level for the driving context, and selecting the coaching messages to be provided to the driver using a multimodal user interface of the coaching arrangement based on a correlation of the determined coaching level and the determined driving context.

### BACKGROUND AND SUMMARY

The present invention relates to a method for providing a coaching message to a driver of a vehicle for encouraging a desired driving behavior of the vehicle. The invention also relates to a corresponding coaching arrangement and a computer program product.

The operation of a vehicle involves a large plurality of different tasks, including for example the more general issues relating to distance and lane keeping, awareness in general (e.g. when driving on a straight road or entering a roundabout), and more complicated traffic situations as well as more specifically in relation to safe and economic operation of the vehicle. Modern vehicles are typically provided with different systems for assistance in these tasks, using for example electronic systems for optimized gear shifting, adaptive cruise control systems taking into account distance keeping, etc.

Additionally, much progress has been made in implementing educational systems in the vehicle for providing feedback to the driver of the vehicle for pointing towards an unsafe operational behavior of the vehicle. Such system may for example allow for the possibility to instruct the driver to take a break in case of the system identifying the driver is becoming drowsy, or for providing a feedback in case the driver fails to comply with regulations relating to the operation of the vehicle.

Even though improvements have been made in correcting the driver when failing to be law abiding or not driving in a safe and economic manner, it would be desirable to provide further improvements for encouraging the driver to operate the vehicle according to a desired driving behavior. Specifically, it would be desirable to allow for the possibility of adjusting the driver feedback to in the most optimal way make the driver conform to the expectations placed on the driver in a specific driving context.

According to an aspect of the invention, the above is at least partly met by a method for providing a coaching message to a driver of a vehicle for encouraging a desired driving behavior of the vehicle, the coaching message provided by means of a coaching arrangement comprised with the vehicle, the method comprising determining a driving context for the vehicle, determining a coaching level for the driving context, and selecting the coaching messages to be provided to the driver using a multimodal user interface of the coaching arrangement based on a correlation of the determined coaching level and the determined driving context.

The invention is based on the understanding that it is desirable to allow for an adaptation of how the driver is encouraged to behave, putting focus on the current situation, i.e. driving context. In each category or layer of driving context, metrics and thresholds may exist to determine criteria for various levels of coaching. The determination of the driving context may thus enable a more optimal encouragement of the driver. For example, the coaching message provided to the driver of the vehicle may be based on the skill set of the driver correlated with the situation in which the vehicle is operated. As an example, in a first context a novice driver may need more encouragement in comparison to a second context with the same traffic situation but a more skilled driver. However the skilled driver may still be in need of some encouragement but communicated in a different way. Continuing on the same example, in a third and a fourth context, that are sharing a traffic situation different from the previous situation, both drivers may need the same coaching, since the criteria for various levels of coaching may be more similar for those specific contexts.

The invention may make use of e.g. existing and future active safety and connected vehicle systems to provide a more rich coaching of the driver when it has been determined, by the coaching arrangement of the vehicle, what specific feedback need to be provided to the driver. Accordingly, the invention provides a platform for means to analyze a driving behavior and, based upon exhibited behavior in specific contexts, determines when driver coaching is needed. Such functionality may for example be used in relation to commercial fleets need to train drivers to drive a truck (or bus etc.) optimally both regarding safety behaviors and regarding fuel efficiency. Improved driver behavior is strongly associated with cost reduction in the form of crash related costs, wear and tear-related costs, and fuel costs.

In a non-limiting example and with reference to the novice and the skilled driver, the coaching arrangement may determine that the novice driver exhibits a lower level of skill in lane keeping (this skill develops with experience) whereby he/she has a more erratic visual glance behavior and looks proportionally many times more towards lane markings in the near regions close to the vehicle instead of the far path region ahead of the vehicle as would an experienced driver with an well-performing, established lane keeping skill set. Also, the coaching arrangement identifies that the novice driver chooses to interact with, for example, a hand held smartphone (e.g. replying to a text message or email) in a risky driving context. Determinable risky driving contexts include dense traffic with stop-and-go traffic queues. Both the distracting behavior and the driving context may be sensed according to the invention and in a corresponding manner determined that this specific driver needs special feedback based both on visual glance behaviors, choice of action, and the resultant impact they have on a lane keeping skill that is underdeveloped. The novice driver would then receive feedback on visual glance behaviors, choice of action, and the specific dangers related to the level of lane keeping skill.

In contrast, the coaching arrangement may determine that the skilled driver (e.g. a professional driver with many year's driving experience) looks proportionally more at the future path of the vehicle and at the rear-view mirrors and exhibits a highly stable lane keeping behavior with low variability of position in lane. Accordingly, when the skilled driver interacts with a handheld smartphone the choice of situation may be better for the driving context, for example the skilled driver would choose to interact with the phone on an open highway with no lead-vehicle. Although both the lane keeping skill-set of the driver and the choice of driving context is better than the novice driver, the skilled driver may still exhibit a dangerously distracting behavior when using the smartphone. According to an embodiment of the invention, there would thus be provided feedback which is more tailored to this context. Feedback would then focus on tips regarding the length and number of glances away from the road and alternative solutions to interact with the device (for example recommending using voice recognition).

In one embodiment of the invention, the method may further comprise providing a notification to the driver that the coaching arrangement begins a coaching session having a predetermined duration. The coaching arrangement may provide an intelligent periodization of coaching so that when a situation where coaching is required is determined or anticipated, the driver may be informed that the coaching arrangement will enter into a coaching session, and the driver may also be informed of the duration of the coaching session.

According to one embodiment of the invention, the driving context may preferably be determined based on an operational context of the vehicle and an operational state of the driver of the vehicle. Thus, by means of the invention the coaching level is adapted to not only the situation in which context the vehicle is in, but also depending on how the driver at that specific point in time is acting. For example, the operational state of the driver may be dependent on the drowsiness level of the driver, for example being based on at least one of a model of sleep latency, time of day, time on task, a circadian rhythm, and a sleep/wake homeostatic process. However, the operational state of the driver may also be dependent on the level of distraction, e.g. due to the driver operating internal systems of the vehicle, including for example the radio, GPS, AC, or other devices, including for example the mobile phone. The driver's operational state may also be dependent on the estimated current work load of the driving task.

According to the present invention, the type of coaching message provided to the driver may have different focus. For example, a coaching message may be provided to the driver for driving safely, economically, defensively, keeping distance in mind, minimizing the duration of glances away from the road. The coaching message may also be “task related”, i.e. for completing a specific and possibly complicated task, such as for driving up a steep road with a heavily loaded truck keeping minimized wear of the truck and economy in mind. In such a specific case the skill level of the driver may be relevant in providing encouragement to the driver, i.e. the skilled driver may be disturbed if receiving general instructions for gear shifting, but would rather be appealed by receiving instructions relating to the finer details for minimizing fuel consumption for a selected section of the steep hill.

Preferably, the operational context of the vehicle is determined based on at least one of a geographical position of the vehicle, a spatial positioning between the vehicle and a further vehicle, a spatial positioning between the vehicle and a vulnerable road user, a position of the vehicle in relation to infrastructure, or an upcoming traffic situation relating to the vehicle.

Accordingly, it is further possible to selectively target the coaching message provided, for example not only being dependent on the type of traffic situation approaching but also bearing in mind the geographical context in which it takes place. A vulnerable road user may for example be a pedestrian or a bicyclist.

Additionally, the operational context may further be dependent on at least one of the time of the day, the weather condition within the surrounding of the vehicle. Hence, the operational context may be dependent on the road being slippery, the vehicle operated at night time, etc. As such and with reference to the above example of the steep hill and bearing the geographical relation in mind, when for example driving late at night, different regulations may apply to driving up the steep hill, thus adapting the coaching message to in the best way encouraging the driver to complete the task.

According to a further embodiment, the operational state of the driver may be determined based on at least one of a driver's interaction with the vehicle, a visual fixation of the driver, a physiological state of the driver, a predetermined profile of the driver of the vehicle, a predetermined risk assessment of the driver of the vehicle, an accumulated behavior of drivers of the type of vehicle, or manually selected in relation to the driver of the vehicle. Thus, the driver may for example manually set the operational state to correspond to his/her skill level. However, the operational state may also be set by a fleet operation based on prerequisite information of the driver.

According to one embodiment of the present invention, the coaching level may be determined based on at least one of a change in the driving context or a correlation between the driving context and accumulated driving contexts disposed by the coaching arrangement. In a non-limiting example of the invention the coaching arrangement may determine that a change in coaching level is required for the driver interacting with a hand-held smartphone on an open highway with no lead-vehicle based on for example the approach of a lead vehicle, the accumulated history of the driver's distraction or a correlation to a database of driving contexts that may be deemed risky. The coaching level may for example be proportionately set based on change of a metric in the driving context or proportionately set based on a correlation factor. That the coaching level may be proportionately set means that a large change of metric or correlation factor may result in a large change in the coaching level.

Preferably, the coaching message is provided in the form of an audio, voice, visual or haptic output from the multimodal user interface. The delivery of the coaching message naturally depends on a range of parameters such as type of event, environmental circumstances, and driver condition. For example, a coaching message encouraging the driver to look timely to the left in an intersection may combine a voice command with a visual indication at the appropriate moment in time. Furthermore the visual indication may either be based on the desired behavior, e.g. a visual indication in the left part of the windscreen. Alternatively, or in combination, the visual indication may be based on an identified behavior of the driver, e.g. if the driver is looking to the right, an indication may be provided on the right side of the windscreen, indicating that the driver should look to the left.

According to another aspect of the invention there is provided a coaching arrangement for providing a coaching message to a driver of a vehicle for encouraging a desired driving behavior of the vehicle, the coaching arrangement comprised in the vehicle, wherein the coaching arrangement comprises means selecting a driving level to be applied to the coaching arrangement, means determining a driving context for the vehicle, means determining a coaching level for the driving context, and means selecting the coaching messages to be provided to the driver using a multimodal user interface of the coaching arrangement based on a correlation of the determined coaching level and the selected driving state. This aspect of the invention provides similar advantages as discussed above in relation to the previous aspect of the invention.

Preferably, the coaching arrangement may further be configured to receive signals from internal and/or external sensors of the vehicle for determining an operational context of the vehicle and an operational context of the driver of the vehicle, the operational context of the vehicle and the operational context of the driver provided for determining the driving context of the vehicle.

Such internal and/or external sensor systems may for example include at least one of a camera system configured to observe the driver of the vehicle, a radar system arranged externally of the vehicle, a camera system configured to monitor the surrounding of the vehicle. Further elements, such as means for receiving map and location data may be included, where the information (e.g. map and location) may be provided using GPS plotter (fixed or mobile).

Driving context and the position and paths of other vehicles may be detected by means of vehicle-to-vehicle or vehicle-to-infrastructure communication technology.

The coaching arrangement may benefit from receiving information from a remote server, for example connected using a wireless connection provided using e.g. a mobile phone connected to the coaching system, or using a similar functionality provided integrated with the vehicle. Remote connection allows for continuous update of the coaching messages provided to the driver, as well as for allowing system upgrades for handling further driving contexts in a suitable manner.

According to a still further aspect of the invention there is provided a computer program product for providing a coaching message to a driver of a vehicle for encouraging a desired driving behavior of the vehicle, the coaching message provided by means of a coaching arrangement comprised with the vehicle, the computer program product comprising code configured to, when executed by a processor of the coaching arrangement code for selecting a driving level to be applied to the coaching arrangement, code for determining a driving context for the vehicle, code for determining a coaching level for the driving context, and code for selecting the coaching messages to be provided to the driver using a multimodal user interface of the coaching arrangement based on a correlation of the determined coaching level and the selected driving state. Also this aspect of the invention provides similar advantages as discussed above.

The computer readable medium may be one of a removable nonvolatile random access memory, a hard disk drive, a floppy disk, a CD-ROM, a DVD-ROM, a USB memory, an SD memory card, or a similar computer readable medium known in the art (present and future). The present invention may be implemented using a combination of software and hardware elements.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 is a perspective view of a vehicle equipped with external sensors and a coordinate system at its front end;

FIG. 2 is a perspective view of the interior of the vehicle, equipped with an internal sensor;

FIG. 3 illustrates a coordinate system of the face and head of a vehicle operator, and

FIG. 4 illustrates a perspective view of the interior of the vehicle, equipped with internal sensors and multimodal feedback means.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

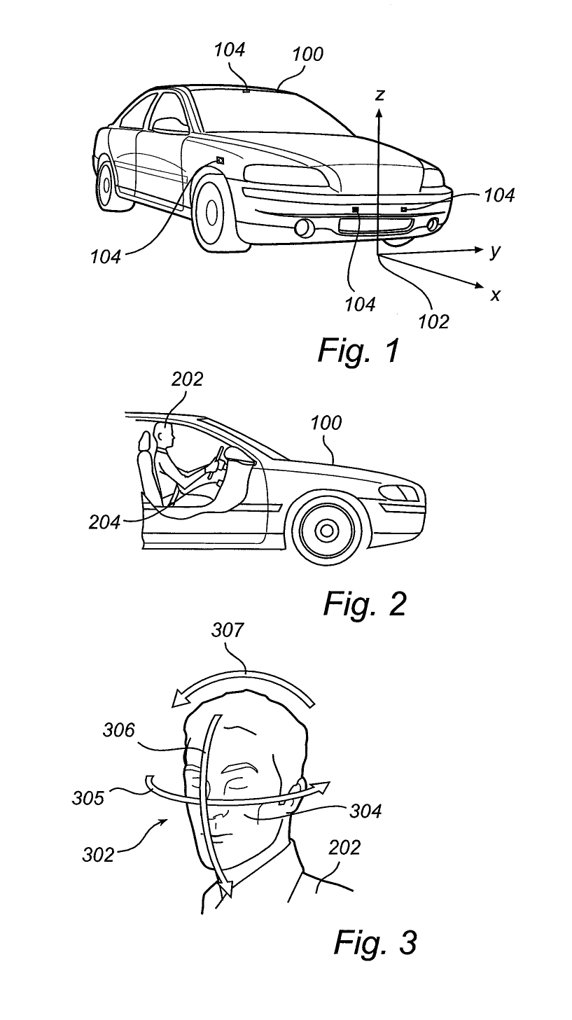

In the following, the present invention is described with reference to a system and a method for providing a coaching message to the driver of a vehicle. The vehicle is preferably equipped with interior sensor(s) for retrieving information of the vehicle operator and external sensor(s) for retrieving information of the vehicle operation as well as the surrounding environment of the vehicle. For the sake of better understanding, the internal and external sensors will now be described in relation to FIGS. 1-3.

FIG. 1 shows an exemplary vehicle, here illustrated as a car 100, in which a system according to the present invention may be incorporated. The car 100 is provided with external sensors 104 arranged to detect vehicle operation, such as overtaking, vehicle speed, vehicle yaw rate, etc, and objects, and zones, surrounding environment of the vehicle, e.g. lane markings, road marks, road curves, surrounding vehicles, etc. The external sensors 104 may be e.g. cameras or radar sensors. Preferably, a combination of camera and radar sensors may be used, since the camera provides a high precision when determining the height and width of the object, whereas a radar sensor provides a high precision when determining the distance to the object. Hereby, size, position, speed, acceleration etc. of the surrounding object can be determined. FIG. 2 illustrates an interior of the car 100 including a vehicle operator 202, wherein the vehicle 100 is equipped with an internal sensor, here illustrated as a camera system 204. The camera system 204 is arranged to measure and detect the behavior of the vehicle operator 202 during vehicle operation, and may be configured to generate an operator motion input signal indicative of physiological data comprising information relating to at least one of eye, face, head and body motion of the operator of the vehicle.

Furthermore, the camera system 204 may be arranged to focus on a predetermined number of positions of the operator's face, head, or upper body. These positions may, for example, be the eyes, eye-lids, eyebrows, nose, mouth, cheek, neck, shoulders, arms, etc. The camera system 204 may be pre-calibrated for a specific operator 202 normally operating the car or being calibrated each time an operator 202 enters the driver seat of the car 100. As the camera system 204 has detected the different positions of the operators face or head, an estimation of facial behavior is possible for the camera system 204. The camera system 204 may hence detect, e.g. head and eye direction and movement, and derivative thereof, head pose, eye saccade, combined head and eye saccade, eye closure, speed of eye closure, etc.

The camera system 204 may also detect if the head, or eyes, of the operator is rotating to the right or left (yaw), 305, rotating up or down (pitch), 306, or, in the case of the head movements, leaning towards the right or left shoulder (roll), 307. Furthermore, the internal sensors may also, instead of, or additionally to the camera system 204, include other type of operator detecting means. This may, for example, include steering wheel sensors for detection of a steering behavior, sensors in the acceleration pedal and/or braking pedal for detection of inconsistent acceleration and/or braking of the car 100, sensors in various buttons of the car 100 to detect if, for example, the operator 202 is adjusting any of the various functionalities of the infotainment system, etc. Further examples of internal sensors may include a breath analysis sensor or pupil size sensor for monitoring state of awareness of the operator.

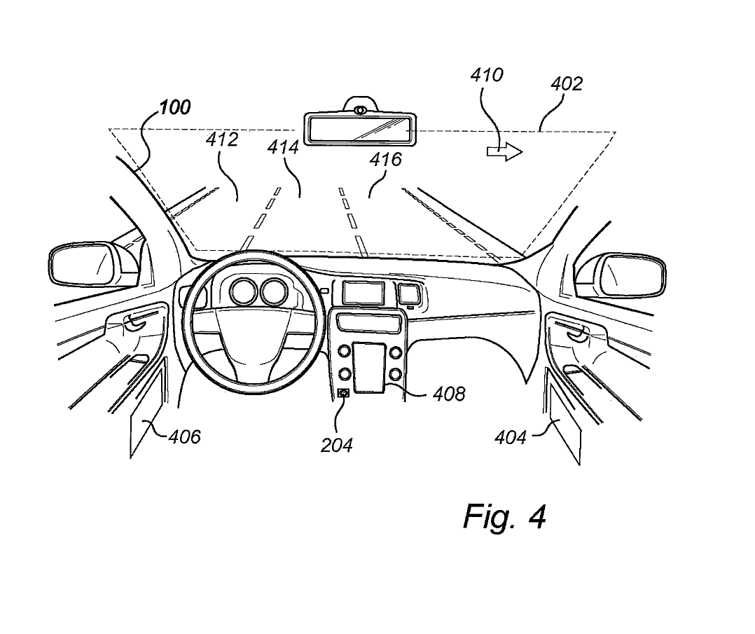

With further reference to FIG. 4, the vehicle 100 is additionally provided with a multimodal interface for providing a rich feedback to the driver 202. In the illustrated example, the multimodal interface comprises a head-up display (HUD) 402, typically integrated with the windshield of the vehicle 100.

Additionally, the multimodal interface of FIG. 4 comprises a speaker 404 arranged in the right-hand side within the vehicle compartment, and a corresponding speaker 406 arranged on the left-hand side of the vehicle compartment. Additionally, a control interface 408 (e.g. touch screen) of the coaching arrangement may be provided for allowing the user to control e.g. the driving level (e.g. relating to a self-observed skill level) of the inventive coaching arrangement.

Furthermore, and with general reference to the invention, the HUD may be configured to allow different types of graphical instructions to appear visible to the driver 202 for encouraging the driver to behave in a specific manner, such as for example by making an “arrow” 410 pointing in a rightward direction. Such a graphical instruction may for example be arranged to appear on the HUD 402 in combination with a spoken instruction provided though the speaker 404 on the right-hand side for the purpose of providing feedback to encourage the driver to change lane from a centrally arranged lane 414 to the right lane 416 due to an upcoming traffic situation (i.e. operational context of the vehicle).

In several embodiments of the invention the method involves providing a context based coaching message that can be activated in one or more situations, which can be viewed in a layered model, with increasing specificity further down in the layers. On the top layer the coaching message can be triggered based on general driving behavior changes. On the next layer the driving behavior is categorized as either efficient driving or safe driving. On the third layer the analysis/categorization is more specific addressing specific elements of each second layer category; such as fuel efficiency, wear and tear, distraction or speeding. On the fourth level the categorization/analysis is very specific, typically addressing the elements that make up the third level categories; such as choice of gear or longitudinal driving behavior for fuel efficiency, or visual glance behavior when negotiating intersections.

In one example, the camera system 204 arranged within the vehicle compartment may be used for identifying for how long time the driver 202 is looking away from the road. In relation to the invention, this information may be used for triggering a message based on any level of context such as, general driving behavior changes, safe driving behavior, distraction or visual glance behavior when negotiating intersections, all depending on the context. The message is aimed at coaching the driver 202 to operate the vehicle 100 according to a (predetermined) safe glance behavior which involves looking away from the road for shorter periods of time and in situations when there is no imminent safety risk. Coaching the driver 202 with focus towards a safe glance behavior involves providing feedback to the driver 202 for informing him that long glances away from the road are very detrimental to safety and that long periods of visual time sharing (glancing back and forth at the road towards a smartphone) is not desirable. Thus the driver should learn to keep glances short (e.g. all below 2 sec) and break up periods of visual time sharing into shorter bursts of time (e.g. below 7 s) with a pause (at least 3 sec looking at the road) in between.

As a comparison, prior art safety systems may for example provides a distraction alert warning based on detection of a long single glance (e.g. 2.3 seconds) or a glance history with too long of a visual time sharing period (e.g. a 50% percent of glances toward road center during a 15 seconds time-averaged window). This type of algorithm has been proven to be very successful in experiments in improving safety as measured by safer glance behavior (less long glances and shorter visual time sharing periods) and improved lane keeping behavior, smoother steering wheel movements, and faster reaction time. One particular potential drawback of the distraction feedback in the form of distraction alert warnings is that they can be quite frequent (up to several warnings per minute). Frequent warnings may lead to annoyance and the driver turning off the system.

An embodiment of the invention on the other hand provides an intelligent periodization of distraction feedback whereby, once e.g. the distracting situation is determined, the driver 202 may be informed that the coaching arrangement will enter into a distraction coaching session—a period of time with detailed feedback regarding distraction. The coaching arrangement determines when this distraction coaching session is needed and schedules or plans for when and how long these periods of time should last. Thus the coaching arrangement has in this example transitioned into a driver distraction coaching “mode” where feedback can be given on the specific details of the situation, context, and specific impact of distracting behaviors given the operational state of the driver. For example, the driver which has the predetermined profile of a novice driver would require a longer period of coaching with more background explanations and more feedback regarding choice of action, alternatives ways of interacting (e.g. voice recognition, phoning for assistance to a call-center or fleet manager), description of the risks exhibited previously by the distracting behavior etc. In a complementing example the driver which has the predetermined higher risk assessment but a profile of a more experienced driver may require coaching that is less focused on background explanations or alternative ways of interaction and more on description of the risks.

Alternative embodiments of coaching situations can be with regard to behaviors detected in intersection management or headway keeping. For example the forward vehicle sensors (e.g. radar, lidar, machine vision) shown in FIG. 1 typically provide an ongoing assessment of the optimum distance to a vehicle ahead and the current level of discrepancy (too close, too far) or danger for crash. This information is currently (i.e. according to prior art) used only when there is a very dangerous situation that merits a forward collision warning or an operational intervention such as an emergency braking or steering to avoid a crash.

However, the information provided by on-board vehicle systems which knows the optimal metrics of headway keeping behavior in the current situation may according to an embodiment of the invention be used to trigger and also to coach the driver about e.g. headway keeping. Further information about changes in operational state of the driver such as abrupt and/or aggressive use of the accelerator and brake may be included in identifying headway keeping problems, such as by following too closely behind another vehicle. By diagnosing such a behavior, the coaching arrangement may start a period of time with headway coaching (a headway coaching “mode”). Rich feedback regarding the use of pedals and the current discrepancy between the current headway and the optimum headway may be provided to the driver 202 when in the headway coaching mode. For example, verbal, recorded descriptions are given or tactile/haptic or visual feedback may be given using the multimodal interface 402/404/406 shown in FIG. 4 with the goal of educating the driver 202 for operating the vehicle according to a desired predetermined driving behavior.

Further exemplifying, if a driver is repeatedly using an unsafe visual glance behavior, the system detects this operational state and provides a coaching message directed at this specific behavior along with a relevant target, e.g. a metric of visual fixation. The system will then monitor the driver's ability to achieve this target and provide feedback on his performance. In this particular case, a driver that is consistently showing a suboptimal visual distraction behavior will receive specific feedback encouraging him to reduce the length of glances away from the road or reduce the duration of visual time sharing, depending on the metric that needs improvement. The driver will receive feedback on this until the system determines his behavior has improved.

In further example of a different driving context a driver that consistently keeps a too short distance to lead vehicles (e.g. shorter than 2 seconds) will be encouraged to increase his headway distance.

In one example, the determined driving context can also entail an imminent emerging critical situation, where the coaching level may be depending on the driver's ability to react in the optimal way to the situation and simultaneously the driver's opportunity to act. For instance, the more time before the emerging critical situation that is available the more opportunities the driver has to act. The time before a possible incident may be divided into the stages: safe, emerging threat, imminent threat and emergency. The driver may have a wide range of opportunities and possibilities to act during the safe stage, while the opportunities and possible actions decrease during the following stages to zero at the time of an incident. The coaching messages may reflect the stages of an emerging situation, for example the driver may be encouraged to act at an increasing rate. Another example is to indicate what actions are possible depending on the current stage, or to indicate only the preferred action. One example of a context could be an imminent collision in an intersection where another vehicle is detected to be entering the path of vehicle 100, at a safe stage of this operational context of the vehicle the driver could receive a message that the driver's attention is encouraged to be directed at the other vehicle, at the emerging threat stage the message could encourage a change in path or speed, and later during the imminent threat stage the message may encourage only adaptation of speed or braking and finally during the emergency stage the driver is encouraged to brake fully. The coaching arrangement may furthermore in this example determine the coaching level based on the operational state of the driver, for example a driver may based on a predetermined profile receive detailed indication of a preferred action at a very early stage or based on another profile receive a more open indication to react at a later stage, in a further example the coaching arrangement would encourage a driver, that has been assessed as having a more risky behavior, to act more defensively, e.g. earlier. In yet another example a driver that does not apply the brakes, turns, have an appropriate visual fixation or at least takes his foot off the accelerator will trigger an earlier coaching message encouraging the driver to act more appropriately in similar situations in the future, even if the driver could have a predetermined profile that would otherwise allow later warnings.

Moreover, the analyzed driving behavior and corresponding coaching message is context dependent meaning that the driving situation and circumstances affect how the behavior is analyzed and subsequently the content and means for providing the coaching message. For example, a driver who is distracted while driving in low speeds in the absence of other vehicles will receive different feedback than one that is distracted while in the midst of a critical driving maneuver, such as overtaking or if the lead vehicle is braking.

In one embodiment of the invention the determination of the operational state of the driver can also be triggered based on the activation of one or more onboard systems, for example distraction context based coaching may be triggered after one or more warnings from a distraction warning system or a predictive mathematical model of drowsiness, e.g. based on circadian rhythm, time of day, duration of prior sleep period, etc., determines that the driver may be at risk of becoming drowsy at some point during the drive triggering drowsiness context based coaching. A further similar example may be that a specific headway keeping context based coaching may be triggered after one or more warnings of a collision or adaptive cruise control system. Furthermore in an example where the vehicle is equipped with such onboard systems the activation of a context based coaching message may also additionally adapt the sensitivity of relevant onboard driving support systems as part of the coaching message. For instance, for a driver that has exhibited a detrimental lane keeping ability and has triggered a lane keeping coaching message, the message could be further supported by increasing the sensitivity of an onboard lane departure warning system, thus enabling that system to issue warnings even for less critical lane departure events.

The implicit activation of one driving context, such as drowsiness, may be triggered by other driving contexts that are determined, for example when ambient light decreases past a predefined limit, or when the current time is within a predefined segment of time of day. Similarly if the driving context is that the vehicle enters a road with multiple lanes, the lane keeping context based coaching is activated.

In alternative embodiments of the coaching arrangement the operational state of the vehicle may include road and map databases that indicate a certain road segment to be a known black spot (safety critical area), which triggers general safety coaching. Possibly, if the exact nature of the safety issues of this area is known, the coaching will be addressing this specific context. For instance, if a certain area is known to have had many accidents with wild animals, the driver will receive coaching about this and be encouraged to keep lower speed and be more vigilant, e.g. visually scanning the areas next to the road. Similarly, if a certain road segment often has problems with black ice, i.e. invisible ice patches, and the road temperature is below for example 3 degrees Celsius, the driver will receive coaching on his speed and distance keeping behavior. Furthermore road and map databases may also be used for future personal feedback, for example if the driver is driving on a road segment where he has previously driven poorly this may trigger a change in driving context that would not have been triggered without this previous information. Also, if the driver currently drives a road segment where previous performance was much better this will trigger coaching messages based on previous performance in order to encourage driving more similar to that.

In embodiments that are applicable for the transport of people or other precious goods, comfort is even more important. Thus if the driver is driving uncomfortably, e.g. turning aggressively, accelerating or braking harshly, or driving too fast over road bumps, a coaching message may for example encourage the driver to drive more comfortably and subsequently receive continuous feedback on the ability to drive comfortably.

In one embodiment, the driving context may include whether the vehicle type is familiar to driver, for example the coaching arrangement may provide basic introduction to a driver that is unfamiliar with the vehicle. Also, if the driver currently drives a vehicle type that the driver has previously driven much better, coaching may be based on previous performance in order to encourage driving more similar to that. Similarly this would be valid for a driver that has the task to drive a vehicle combination, e.g. extra heavy or long vehicles, of which he has little or no experience, safe and efficient coaching is activated and used to improve his performance.

As previously mentioned, in all cases above the specific formulation of the coaching message, feedback and the targets may be dependent on the determined operational state of the driver. For example a driver with a predetermined profile that corresponds to a more skilled driver may receive a message that is more supportive in nature, e.g. “please increase headway distance”, while a predetermined profile corresponding to a novice driver may receive much more detailed instructions, e.g. “please keep 3 sec to lead vehicle”. Furthermore, the coaching may make use of context-specific feedback based on metrics for that specific context and the divergence from that metric. For example, a driver showing high visual distraction, with too long glances away from the road, will be specifically encouraged to reduce glance length, and the continuous feedback will measure the length of glances away from the road. Whereas a driver who consistently drives with a too short distance to lead vehicle will be specifically encouraged to increase his headway time gap and receive continuous feedback on his average headway distance while driving. An example where a metric correlating to a driving context may be both Boolean and real is triggered by a camera system used to detect traffic signs, followed by monitoring of the driver's response in conjunction with the appearance of the sign. In this example the message could encourage adherence to the traffic sign or a more timely reaction. In a similar example a camera system detects the onset of brake lights of a vehicle in the driving path. Monitoring of the driver's response to a vehicle braking can generate coaching message, especially after repeated events, which could be one metric. Alternatively, a driver that consistently maintains the foot on the accelerator pedal for several seconds after the brake lights came on may be deemed unsafe based on the timing metric. Coaching level and coaching messages may be determined based on the relative difference to a preferred value of a driving context metric.

In several embodiments of the invention the determination of driving context can be based on a generated average driving context over an extended time period (or driving distance), or it can be based on a shorter time period, or even momentary based on a single or a small number of events, or a combination of several of these.

Even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. For example, the invention has mainly been described above with reference to a few embodiments. However, as is readily appreciated by the skilled addressee, other embodiments than the ones disclosed above are equally possible within the scope of the invention, as defined by the appended patent claims. For example, the invention is also applicable for trucks, buses, dumpers, wheel loaders and other types of vehicles.

In the claims, the word “comprises” does not exclude other elements or steps, and the indefinite article “a” or “an” does not exclude a plurality. A single computer or other unit may fulfill the functions of several items recited in the claims. The mere fact that certain measures are recited in mutually different dependent claims does not indicate that a combination of these measured cannot be used to advantage.

1. A method for providing a coaching message to a driver of a vehicle for encouraging a desired driving behavior of the vehicle, the coaching message provided by means of a coaching arrangement comprised with the vehicle, the method comprising:
determining a driving context;
determining a coaching level for the driving context, and
selecting the coaching messages to be provided to the driver using a multimodal user interface of the coaching arrangement based on a correlation of the determined coaching level and the determined driving context.

2. Method according to claim 1, further comprising:
providing a notification to the driver that the coaching arrangement begins a coaching session having a predetermined duration.

3. Method according to claim 1 or 2, wherein the driving context is determined based on an operational context of the vehicle and an operational state of the driver of the vehicle.

4. Method according to claim 3, wherein the operational context of the vehicle is determined based on at least one of a geographical position of the vehicle, a spatial positioning between the vehicle and a further vehicle, a spatial positioning between the vehicle and a vulnerable road user, a spatial position of the vehicle in relation to infrastructure, or an upcoming traffic situation relating to the vehicle.

5. Method according to any one of claim 3 or 4, wherein the operational state of the driver of the vehicle is determined based on at least one of an interaction with the vehicle and the driver, a visual fixation of the driver, a physiological state of the driver, a predetermined profile of the driver, a predetermined risk assessment of the driver, an accumulated behavior of drivers of the type of vehicle, or manually selected in relation to the driver of the vehicle.

6. Method according to any one of claim 3 or 4, wherein the operational state is set by a fleet operation based on prerequisite information of the driver.

7. Method according to any one of the preceding claims, wherein the coaching level is determined based on at least one of a change in driving context or a correlation between the driving context and an accumulated driving context.

8. Method according to any one of the preceding claims, wherein the coaching level is proportionately determined based on at least one of a change in driving context or a correlation between the driving context and an accumulated driving context.

9. Method according to any one of claims 3 to 8, wherein the operational context depends on at least one of: the time of the day, the weather condition within the surrounding of the vehicle.

10. Method according to any one of the preceding claims, wherein the coaching message is provided in the form of an audio, voice, visual or haptic output from the multimodal user interface.

11. Method according to any one of the preceding claims, wherein the coaching message is provided to the driver for driving safely, economically, defensively, keeping distance in mind, minimizing the duration of glances away from the road.

12. A coaching arrangement for providing a coaching message to a driver of a vehicle for encouraging a desired driving behavior of the vehicle, the coaching arrangement comprised in the vehicle, wherein the coaching arrangement comprises:
means determining a driving context;
means determining a coaching level for the driving context, and
means selecting the coaching messages to be provided to the driver using a multimodal user interface of the coaching arrangement based on a correlation of the determined coaching level and the determined driving context.

13. Coaching arrangement according to claim 12, wherein the coaching arrangement is further configured to receive signals from internal and/or external sensors of the vehicle for determining an operational context of the vehicle and an operational context of the driver of the vehicle, the operational context of the vehicle and the operational context of the driver provided for determining the driving context.

14. Coaching arrangement according to claim 12, wherein the internal and/or external sensors of the vehicle comprises at least one of a camera system configured to observe the driver of the vehicle, a radar system arranged externally of the vehicle, a camera system configured to monitor the surrounding of the vehicle.

15. Coaching arrangement according to claim 14, wherein the camera system is provided for identifying for how long time the driver is looking away from a road onto which the vehicle is driven.

16. A computer readable medium embodying a computer program product for providing a coaching message to a driver of a vehicle for encouraging a desired driving behavior of the vehicle, the coaching message provided by means of a coaching arrangement comprised with the vehicle, the computer program product comprising code configured to, when executed by a processor of the coaching arrangement:
code for determining a driving context;
code for determining a coaching level for the driving context, and
code for selecting the coaching messages to be provided to the driver using a multimodal user interface of the coaching arrangement based on a correlation of the determined coaching level and the determined driving context.
